(19) United States
(12) Patent Application Publication
(10) Pub. No.: US 2026/0228765 A1
(43) Pub. Date: Aug. 6, 2026

(54) AUTOMATED ITEM ASSORTMENT SELECTION USING PROCESSOR-BASED OBJECTIVE FUNCTION EVALUATION OF DESIGNATED GOAL SCORES

(71) Applicant: Dell Products L.P., Round Rock, TX (US)

(72) Inventors: Sumit Wadhwa, Austin, TX (US); Andrew Crane-Droesch, Philadelphia, PA (US); Souvik Nath, Howrah (IN); Prateek Srivastava, Cedar Park, TX (US); Siamak Saliminejad, Austin, TX (US); Akhil Koppera, Austin, TX (US); Andrey Gustavo De Souza, Formiga (BR)

(21) Appl. No.: 19/047,271

(22) Filed: Feb. 6, 2025

(51) Int. Cl. G06Q 30/0202; G06Q 30/0601

(52) U.S. Cl. CPC G06Q 30/0202; G06Q 30/0603

(57) ABSTRACT

Techniques are provided for automated item assortment selection using processor-based objective function evaluation of designated goal scores. One method comprises obtaining information characterizing a plurality of items, a performance of the plurality of items and a plurality of designated attainment goals of an organization associated with the plurality of items; applying at least portions of the obtained information to at least one algorithm to obtain data characterizing a selected item assortment comprising a subset of the plurality of items, wherein the at least one algorithm evaluates a plurality of item assortments, each comprising a different assortment of the plurality of items, wherein the selected item assortment is selected using an objective function that evaluates an attainment score for the plurality of designated attainment goals of the organization; and initiating processing steps based on the selected item assortment.

### BACKGROUND

It is often necessary to determine an assortment of items, from among a larger number of available items. A catalog, for example, may identify an assortment of items provided by a given organization.

### SUMMARY

Illustrative embodiments of the disclosure provide techniques for automated item assortment selection using processor-based objective function evaluation of designated goal scores. One method includes accessing at least one first data structure comprising data characterizing a plurality of items and a performance of the plurality of items; accessing at least one second data structure comprising data characterizing a plurality of designated attainment goals of an organization associated with the plurality of items; applying at least portions of the first data structure and the second data structure to at least one processor-based algorithm to obtain data characterizing a selected item assortment comprising a subset of the plurality of items, wherein the at least one processor-based algorithm evaluates a plurality of item assortments, each comprising a different assortment of the plurality of items from the first data structure, and wherein the selected item assortment is selected using at least one processor-based objective function that evaluates, for at least a subset of the plurality of item assortments, an attainment score for the plurality of designated attainment goals of the organization in the second data structure; and initiating one or more processing steps based at least in part on the selected item assortment.

Illustrative embodiments can provide significant advantages relative to conventional techniques. For example, technical problems related to such conventional techniques are mitigated in one or more embodiments by employing at least one processor-based objective function that evaluates, for each candidate item assortment, an attainment score for designated attainment goals of an organization.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for automated item assortment selection using processor-based objective function evaluation of designated goal scores in accordance with an illustrative embodiment;

FIG. 2 illustrates an example workflow for selecting an item assortment using machine learning (ML) techniques in accordance with an illustrative embodiment;

FIG. 3 illustrates an example of the item assortment selection platform of FIG. 1 in further detail in accordance with an illustrative embodiment;

FIG. 4 illustrates exemplary pseudocode for a genetic algorithm (GA)-based assortment selection process in accordance with an illustrative embodiment;

FIG. 5 is a table illustrating exemplary attainment goals and corresponding equations for evaluating such attainment goals in accordance with an illustrative embodiment;

FIG. 6 illustrates an example of a language model-based item assortment agent in accordance with an illustrative embodiment;

FIG. 7 is a flow diagram illustrating an exemplary implementation of a process for automated item assortment selection using processor-based objective function evaluation of designated goal scores in accordance with an illustrative embodiment;

FIG. 8 illustrates an exemplary processing platform that may be used to implement at least a portion of one or more embodiments of the disclosure comprising a cloud infrastructure; and

FIG. 9 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for automated item assortment selection using processor-based objective function evaluation of designated goal scores.

In one or more embodiments, techniques are provided for item catalog generation using artificial intelligence (AI) techniques. A catalog often identifies an assortment of items provided by a given organization. Assortment planning involves leveraging AI and/or ML techniques to automatically determine a desirable (e.g., optimal) combination of items that will yield a good (e.g., best) result. Items provided by the given organization may be selected based on a transaction history associated with each item, as well as a performance forecast and other factors (e.g., a price of each item). These strategies may help to ensure that the given organization is not losing money and meets annual targets (e.g., regardless of whether or not promotions are applied).

In at least some embodiments, the disclosed techniques for objective function-based item assortment selection generate item assortment recommendations (e.g., global recommendations or per-region recommendations) that will improve (e.g., maximize) one or more designated metrics, such as a units-revenue-margin (URM) metric, or another metric that can be used to analyze profitability, production volumes and/or pricing strategies, while also reducing (e.g., minimizing) a size of the catalog. The item assortment recommendations may be responsive to changing market, technology, commodity trends, and competition offerings, for example.

In some embodiments, the disclosed item assortment generation techniques utilize historical sales data to assess the performance of different item configurations in one or more markets. While offering a given item in a given market, such as laptop computers in a particular country or region, factors such as market conditions and demand may be considered. Market data may provide insights into competitors and overall market conditions. Additionally, item and pricing data may be leveraged to provide guidance in offering various items, line-of-business (LOB) configurations and prices. Forecasting may be employed to understand how specific items or configurations are likely to sell, their pricing, and the impact of future large-scale trends. For example, if a large semiconductor chip provider introduces a new processor with a focus on graphical processing units (GPUs), for example, the disclosed item assortment selection platform may align the items offerings with such market trends.

One or more predefined LOBs may be employed to help organize items. Separate LOBs may be provided, for example, for laptop computers and desktop computers. Within the laptop computer category, for example, there may additional LOBs, such as a different LOB for each model of laptop computer. Each LOB may represent a separate team responsible for determining the item assortments offered in different markets. In some embodiments, a selected item assortment for a given geographic region may be a combination of LOB item assortments (where the item assortment selection is performed separately for each LOB, each potentially with their own attainment goals).

The generated item catalogs may encompass all LOBs for each country or region, for example, and within each LOB, the generated item assortments may specify the available items. For example, within an LOB associated with a given model of laptop computer, different platforms may be defined such as Platform 1, Platform 2, and so on, each with a different configuration (e.g., unique characteristics and features). These platforms may serve as segments within the given laptop model line. For example, one platform may be designed for premium usage with a focus on powerful processors, while another platform may be designed for gaming to prioritize gaming features.

The success of different platforms may depend on the platform configurations. A comprehensive item assortment may be created that covers all elements within a specific country or region, including various LOBs and the platforms associated with such LOBs. These LOBs may be defined within their respective platforms and the best item combinations to offer in a given market may be determined, in some embodiments. Specific business guidelines and rules may be followed, with a focus on improving (e.g., maximizing) one or more business objectives, such as revenue or profit. One business strategy may revolve around increasing market awareness and increasing (e.g., maximizing) a number of units sold. Such key performance indicators (KPIs) may play an important role in the decision-making process. Furthermore, opportunities are explored for upselling, where higher-priced configurations are promoted or offerings within a certain range may be limited. Such practices may be customized to specific businesses and/or contexts.

In one or more embodiments, the disclosed item assortment selection platform may observe sales trends, for example, through the sales patterns of similar countries or through global and local market sales patterns to generate item catalogs tailored to individual countries or regions. ML techniques may be employed in some embodiments with respect to, for example, ranking, forecasting, learning to rank (LTR) and pricing. The disclosed item assortment selection platform may aim to improve (e.g., optimize) one or more designated KPIs (e.g., in a feedback manner). Large-scale trends may be observed and the obtained trend information may be provided to the disclosed item assortment selection platform for better forecasting and pricing. Cannibalization and/or item diversification may optionally be considered in finalizing the recommendation of item assortments.

A forecast that addresses trends, seasonality and/or cannibalization aspects (e.g., globally or with respect to one or more similar countries or regions) may be reviewed to select, for example, one or more high performing item configurations. The one or more high performing item configurations may be merged in some embodiments with other item configurations to generate a final item assortment.

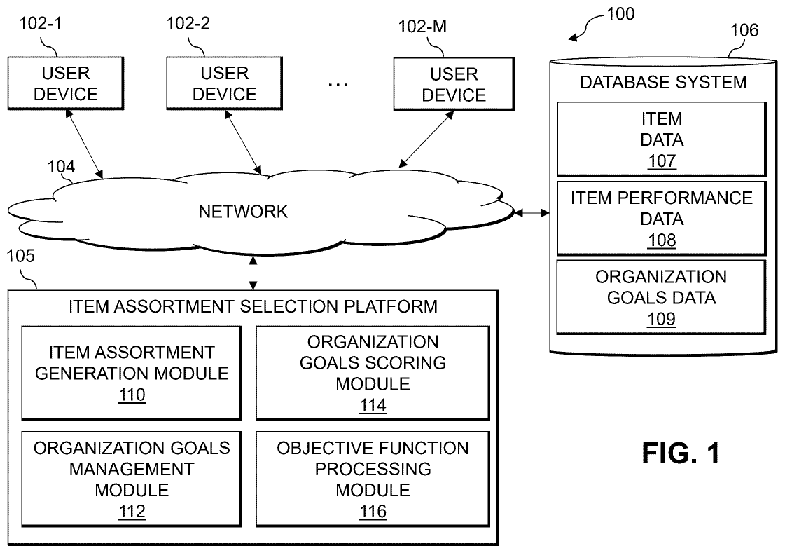

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is an item assortment selection platform 105 and a database system 106.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

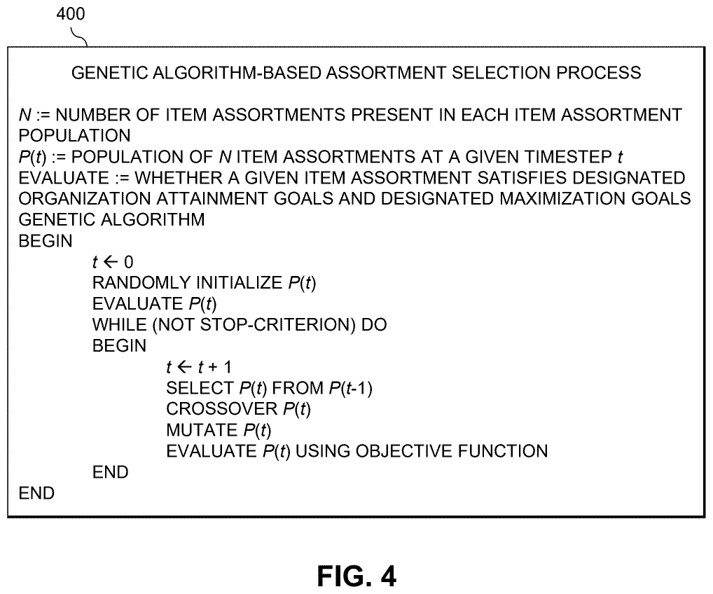

The item assortment selection platform 105 may comprise an item assortment generation module 110, an organization goals management module 112, an organization goals scoring module 114 and an objective function processing module 116. The item assortment generation module 110, in some embodiments, may generate multiple candidate item assortments, as discussed further below in conjunction with FIG. 4, for example, for consideration by the disclosed objective function-based item assortment selection techniques. In at least some embodiments, the organization goals management module 112 may provide a mechanism for managing and updating one or more designated organization goals.

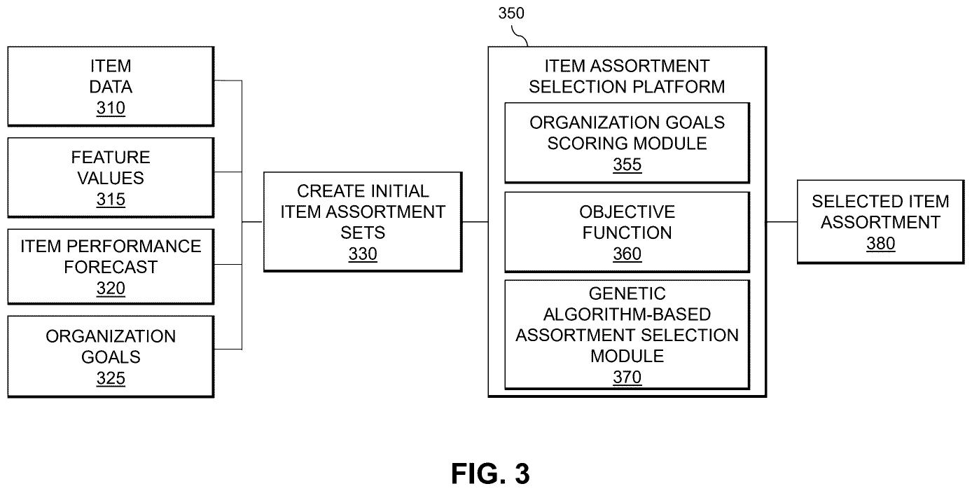

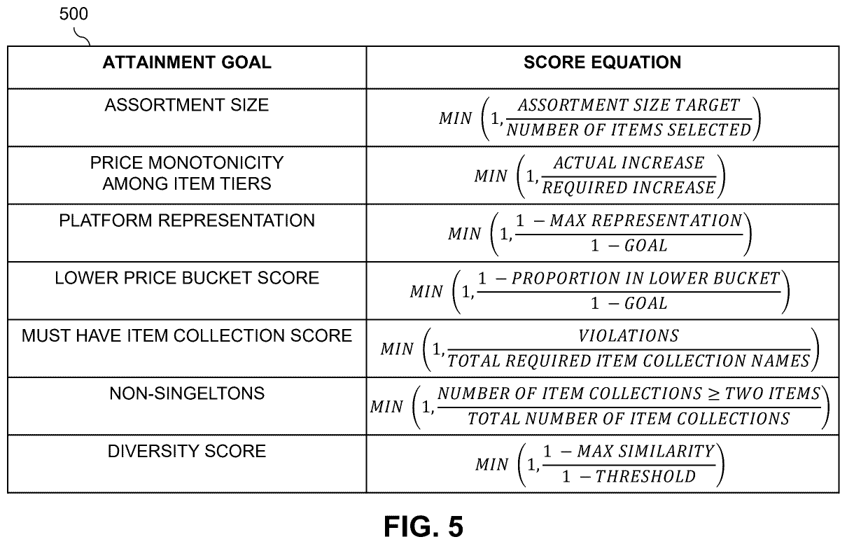

In one or more embodiments, the organization goals scoring module 114 may determine a score that quantifies a compliance of a given item assortment with respect to one or more designated organization goals, as discussed further below in conjunction with FIG. 5, for example. The objective function processing module 116 may be used to evaluate an objective function for a given item assortment, as discussed further below in conjunction with FIGS. 3 and 4, for example.

It is to be appreciated that this particular arrangement of elements 110, 112, 114 and/or 116 illustrated in the item assortment selection platform 105 of the FIG. 1 embodiment is presented by way of example only, and alternative arrangements can be used in other embodiments. For example, the functionality associated with the elements 110, 112, 114 and/or 116 in other embodiments can be combined into a single module, or separated across a larger number of modules. As another example, multiple distinct processors can be used to implement different ones of the elements 110, 112, 114 and/or 116 or portions thereof.

At least portions of elements 110, 112, 114 and/or 116 may be implemented at least in part in the form of software that is stored in memory and executed by a processor.

Additionally, the database system 106 may comprise one or more databases, such as databases comprising item data 107 (e.g., comprising information characterizing a plurality of item), item performance data 108 (e.g., comprising information characterizing a performance of items), and organization goals data 109 (e.g., comprising information characterizing a plurality of organization goals, such as attainment goals, as discussed further below in conjunction with FIG. 5). The databases may be configured to store data, for example, in tables, in a known manner. While the database 106 is illustrated in FIG. 1 as comprising distinct databases, at least portions of the databases may be implemented using a single database (e.g., different parts of a single database). Example databases such as depicted in the present embodiment, can be implemented using one or more storage systems associated with the item assortment selection platform 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the item assortment selection platform 105 are one or more input-output devices, which illustratively comprise keyboards, displays or other types of input-output devices in any combination. Such input-output devices can be used, for example, to support one or more user interfaces to the item assortment selection platform 105, as well as to support communication between item assortment selection platform 105 and other related systems and devices not explicitly shown.

Additionally, the item assortment selection platform 105 in the FIG. 1 embodiment is assumed to be implemented using at least one processing device. Each such processing device generally comprises at least one processor and an associated memory, and implements one or more functional modules for controlling certain features of the item assortment selection platform 105.

More particularly, the item assortment selection platform 105 in this embodiment can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage drive, a storage array or an integrated circuit containing memory, as well as a wide variety of other types of computer program products. The term “article of manufacture” as used herein should be understood to exclude transitory, propagating signals. These and other references to “drives” herein are intended to refer generally to storage devices, including solid-state drives (SSDs), and should therefore not be viewed as limited in any way to particular storage media types.

The network interface allows the item assortment selection platform 105 to communicate over the network 104 with the user devices 102, and illustratively comprises one or more conventional transceivers.

It is to be understood that the particular set of elements shown in FIG. 1 for the item assortment selection platform 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the item assortment selection platform 105 and at least portions of the database system 106 can be on and/or part of the same processing platform.

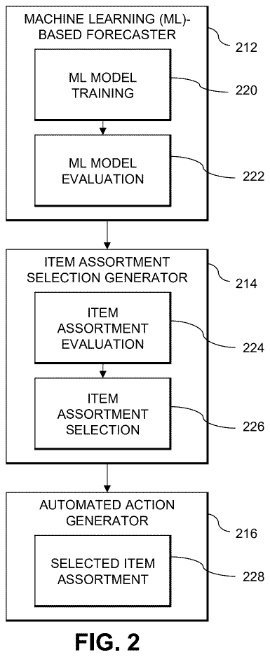

FIG. 2 illustrates an example workflow for selecting an item assortment using ML techniques in accordance with an illustrative embodiment. In the example of FIG. 2, an ML-based forecaster 212, an item assortment selection generator 214 and an automated action generator 216 comprise workflows that are executed in sequential order to select an item assortment. Accordingly, in connection with ML-based forecaster 212, such an example embodiment includes training, in step 220, at least one ML model to forecast one or more variables, and evaluating, in step 222, the at least one trained ML model with respect to multiple outputs.

Such an example embodiment can also include, in connection with item assortment selection generator 214, using at least one algorithm (e.g., at least one GA) to evaluate, in step 224, one or more item assortments, and using the at least one algorithm to determine, in step 226, one or more item assortment selections. Further, as depicted in FIG. 2, in connection with automated action generator 216, step 228 includes executing one or more automated actions (e.g., processing steps) based at least in part on the one or more determined selected item assortment.

FIG. 3 illustrates an example of the item assortment selection platform of FIG. 1 in further detail in accordance with an illustrative embodiment. In the example of FIG. 3, item data 310, feature values 315, item performance forecasts 320 and/or organization goals 325 may be evaluated to create one or more initial item assortment sets 330 (e.g., using the item assortment generation module 110). The item data 310 may comprise, for example, item metadata and/or item attributes. The item metadata and/or item attributes may be processed, for example, to identify similar items (e.g., as part of an evaluation of a diversity of a given item assortment that may promote avoiding similar items in an item assortment).

In some embodiments, the item performance forecasts 320 (e.g., item forecasts or forecasts related to multiple items associated with, for example, a particular model, platform or LOB in a higher level of an item hierarchy) may be processed to distribute a forecast associated with higher level of the item hierarchy to items in a lower level of the item hierarchy. At least one ratio forecasting model may be employed, for example, to process at least one first forecast generated for at least one item in a first item hierarchy level and to generate at least one second forecast for one or more items in a lower item hierarchy level using an item-level ratio for the one or more items in the lower item hierarchy level.

In one or more embodiments, a forecasted demand for one or more items in a given geographic area (e.g., a country or region) may be generated by processing a forecasted demand for one or more items associated with a different geographic area, than the given geographic area, that satisfies one or more designated similarity criteria with respect to the given geographic area. For example, if an item performance forecast 320 is available for the United Kingdom, the item performance forecast 320 for the United Kingdom may be leveraged to forecast items in one or more similar countries, such as Ireland (or Norway being similar to Sweden). The similarity may be with respect to proximity or other similarities. In this manner, operations can be scaled in countries with smaller revenue by leveraging the data available for similar countries, allowing patterns and insights to be extracted from such similar countries using a transfer learning approach.

In at least one embodiment, the forecasted demand for one or more items may be based on competitor demand data and/or market trend data. For example, global and/or local market trends may be combined by analyzing top-performing item configurations in similar countries. Sales data from different vendors, as well as industry contacts, may be processed to understand the demand in a given local market.

The one or more initial item assortment sets 330 may be applied to an item assortment selection platform 350 comprising an organization goals scoring module 355, an objective function 360 and a GA-based assortment selection module 370. The organization goals scoring module 355 may determine a score that quantifies a compliance of a given item assortment with respect to one or more designated organization goals 325, as discussed further below in conjunction with FIG. 5, for example. The objective function 360 may assign a score to each item assortment considered by the item assortment selection platform 350, as discussed further below in conjunction with FIG. 4.

In some embodiments, the objective function 360 may comprise a blended objective function that addresses, for example, trading one goal for another goal (e.g., one may need to sacrifice units to obtain desired margins and vice versa, suggesting a linear and symmetric-around-attainment objective function). The blended objective function may also address attaining the designated attainment goals.

The objective function 360 may be expressed, for example, as follows:

$$score = \{ \begin{matrix}{\sum }_{a ϵ goals} - min {( 0 , ( {p}_{a} - 1 ) )}^{2} , & if {p}_{a} > 1 ∀ a ϵ attainment goals \\ ( {\sum }_{m ϵ goals} ELU ( 100 {c}_{m} {p}_{m} ) / 100 ) & otherwise {∀}_{m} ϵ maximization goals\end{matrix}$$

where ELU is an exponential linear unit, each cm is a prioritization coefficient defined by a given organization, and pᵢ corresponds to a given attainment goal (e.g., corresponding to the designated organization goals 325 or other business rules defined by an organization, where pₐ is used to represent the attainment goals in first portion of the representative objective function 360 related to attainment goals and pₘ is used to represent the attainment goals in second portion of the representative objective function 360 related to the maximization goals). The first portion of the representative objective function 360 aims to ensure that the attainment goals are satisfied (e.g., that pₐ is greater than 1 for all goals in the set of attainment goals), as discussed further below in conjunction with FIG. 4. The second portion of the representative objective function 360 aims to increase (e.g., maximize) one or more designated maximation goals (e.g., when the attainment goals are satisfied).

The one or more designated maximation goals may comprise a URM metric, where each units, revenue margin component may be separately weighted. In some embodiments, the URM metric may be computed separately for LOBs and/or country (e.g., a combination of item assortments at the LOB level).

In one or more embodiments, the objective function 360 may first try to reach the designated attainment goals, which may be strictly non-positive. If the objective function 360 can reach the designated attainment goals, the objective function 360 may pursue the maximization goals. The maximization goals may be multiplied by 100 in some embodiment to be in percentage units and then transformed (e.g., using an ELU) to be strictly positive. The maximization goals may be modified by the organization by the prioritization coefficients, cm.

It is noted that the output of the objective function 360 may be discontinuous at zero (e.g., a slight move from almost-attainment to attainment would cause the positive part of the function to apply), and the corresponding value of the function could be orders of magnitude bigger. It is important that the values of the objective function 360 are consistent in an ordinal way; hence a higher score may be preferred to a lower score, irrespective of their actual values.

The organization goals 325 may be managed and/or updated by the organization goals management module 112. The organization goals 325 may comprise business constraints and/or rules of a given organization that a selected item assortment 380 should adhere to. For example, the business constraints or rules may indicate that the item assortments should be sufficiently diverse; should have an equitable representation from multiple item categories; and/or that the recommended selling price of assorted items between different platforms should increase monotonically by tier (e.g., entry, mainstream and premium tiers), as discussed further below in conjunction with FIG. 5. Such criteria may be incorporated using negative attainment goals in the objective function 360.

The GA-based assortment selection module 370, in some embodiments, may focus on item assortments achieving such attainment goals before evaluating a designated business objective (e.g., to increase URM). The GA-based assortment selection module 370 may be implemented, at least in part, using the techniques described in conjunction with FIG. 4.

FIG. 4 illustrates exemplary pseudocode for a GA-based assortment selection process 400 in accordance with an illustrative embodiment. The GA-based assortment selection process 400 may be executed by or under the control of at least one processing system and/or device. For example, the example GA-based assortment selection process 400 may be viewed as comprising a portion of a software implementation of at least part of item assortment selection platform 105 of the FIG. 1 embodiment.

In the example of FIG. 4, the GA-based assortment selection process 400 uses the exemplary GA and, for the number of item assortments present in each population and for the population of N item assortments at a given timestep t, evaluates whether a given item assortment satisfies the designated organization attainment goals and the designated maximization goals. As noted above, in some embodiments, the GA-based assortment selection process 400 may only evaluate the designated maximization goals in response to the designated organization attainment goals being satisfied.

The designated attainment goals may be considered hard targets that should be satisfied before the one or more designated maximization goals are maximized. In some embodiments, one or more designated attainment goals may be considered soft targets by adjusting a corresponding threshold accordingly.

In one or more embodiments, the GA-based assortment selection process 400 will continue to iterate until one or more designated stopping criteria are satisfied. For example, the stopping criteria may be defined to stop iterating in response to an insufficient improvement, from one iteration to a next iteration, as long as a designated number of iterations have been attempted.

It is to be appreciated that the particular example pseudocode of FIG. 4 shows just one example implementation of carrying out item assortment selection optimizations using an example GA, and alternative implementations can be used in other embodiments, such as linear integer programming techniques.

It is to be appreciated that some embodiments described herein utilize one or more AI models. It is to be appreciated that the term “model,” as used herein, is intended to be broadly construed and may comprise, for example, a set of executable instructions for generating computer-implemented recommendations and/or predictions. For example, one or more of the models described herein may be trained to generate recommendations and/or predictions based at least in part on component demand data and component modification information, and such recommendations and/or predictions can be used to initiate one or more automated actions (e.g., executing component prices, automatically training ML models based at least in part on the recommendations and/or predictions, etc.).

For a further discussion of GA, see, for example, John H. Holland, Genetic Algorithms, Scientific American, Vol. 267, No. 1, 66-73 (July 1992), incorporated by reference herein in its entirety.

FIG. 5 is a table 500 illustrating exemplary attainment goals and corresponding equations for evaluating such attainment goals in accordance with an illustrative embodiment. In the example of FIG. 5, the designated attainment goals comprise the following representative attainment goals:
(1) an assortment size goal to limit a size of the acceptable item assortment for each LOB calculated, as follows:

$$Assortment Size Score = MIN ( 1 , \frac{ASSORTMENT SIZE TARGET}{NUMBER OF ITEMS SELECTED} ) ;$$

(2) a price monotonicity goal among tiers (e.g., whether a price is consistently increasing for selected items between item tiers (e.g., entry, mainstream and premium tiers) calculated, as follows:

$$Price Monotonicity Score = MIN ( 1 , \frac{ACTUAL INCREASE}{REQUIRED INCREASE} ) ;$$

(3) a platform representation goal to ensure that there was a set of items selected from every platform (e.g., a collection of items) and that the item assortment is not only comprised of best-selling items (e.g., a 20% threshold (configurable) indicates that more than 20% of items in an item assortment should not all from a given platform) calculated, as follows:

$$Platform Representation Score = MIN ( 1 , \frac{1 - MAX REPRESENTATION}{1 - GOAL} ) ;$$

(4) a lower price bucket goal to limit a number of items in an item assortment that are below a particular price bucket calculated, as follows:

$$Lower Price Bucket Score = MIN ( 1 , \frac{1 - PROPORTION IN LOWER BUCKET}{1 - GOAL} ) ;$$

(5) a must have item names goal to ensure that certain LOBs have been included in the item assortment calculated, as follows:

$$Must Have Item Names Score = MIN ( 1 , \frac{VIOLATIONS}{TOTAL REQUIRED ITEM COLLECTION NAMES} ) ;$$

(6) a non-singletons goal to ensure that only one item is not selected from a single platform, and that at least two items are selected from a particular platform, when possible, calculated, as follows:

$$Non - Singletons Score = MIN ( 1 , \frac{NUMBER OF ITEM COLLECTIONS \geq TWO ITEMS}{TOTAL NUMBER OF ITEM COLLECTIONS} ) ;$$

and
(7) a diversity score to ensure that if the configuration of the items in a given item assortment are not similar (e.g., using a Jacard index for a number of similar item components, such as processor type, memory size, storage size and screen size) between 2 items) by more than a particular given threshold (e.g., 0.8) calculated, as follows:

$$Diversity Score = MIN ( \frac{1 - MAX SIMILARITY}{1 - THRESHOLD} ) .$$

In one or more embodiments, one or more scores, such as the diversity score, for the designated attainment goals of a given organization may be computed at a higher item hierarchy level than the item level, as would be apparent to a person of ordinary skill in the art. For example, platform-level information (e.g., where a platform comprises a collection of items) may be derived for an item assortment from the items selected for the item assortment, to validate one or more of the designated attainment goals (e.g., platform representation and diversity goals). In general, the designated attainment goals can be configured to be applied at an item level, a platform level and/or an LOB level, as would be apparent to a person of ordinary skill in the art. Consider an exemplary selected item assortment comprising item 1, item 2, item 7 and item 10. Assume that a platform representation target threshold of 30% at the LOB level is used for all platforms in a given laptop product line (and the maximum platform representation value is used to check all platforms, as opposed to separately checking for each platform) and that items 1 and 2 came from a first platform, item 7 came from a third platform and item 10 came from a fourth platform. Thus, the platform representation for the first platform is 50% (2 items/4 items), for the third platform is 25% (1 item/4 items) and for the fourth platform is 25% (1 item/4 items). The maximum platform representation value in this example is 50% so the current item assortment will be modified by the GA-based assortment selection process 400 of FIG. 4 in the set of item assortments.

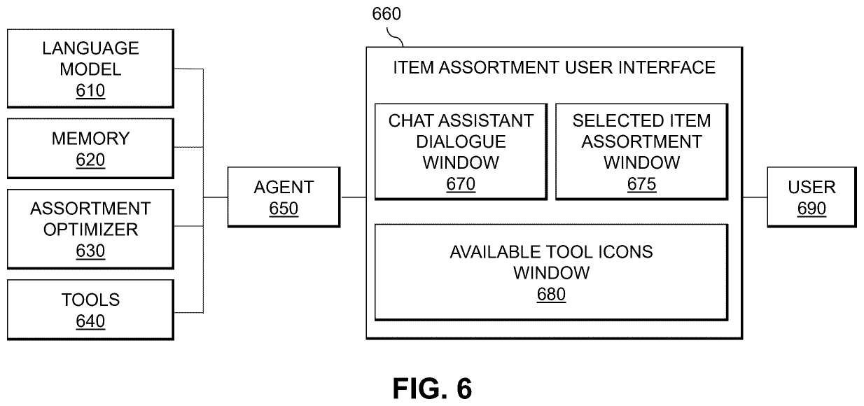

FIG. 6 illustrates an example of a language model-based item assortment agent in accordance with an illustrative embodiment. In the example of FIG. 6, the language-model-based item assortment agent may comprise a language model 610, a memory 620, an assortment optimizer 630, one or more additional tools 640 and an agent 650. The agent 650 interacts with a user 690 by means of an item assortment user interface 660.

In one or more embodiments, the user 690 may interact with the item assortment user interface 660 and the agent 650 to develop, review and/or publish one or more selected item assortment (e.g., product catalogs). In one implementation, the agent 650 may be implemented as a software application that comprises (or provides access to) the language model 610, the memory 620, the assortment optimizer 630 and/or the one or more additional tools 640.

The language model 610 may be implemented, for example, using a large language model such as a generative pre-trained transformer (e.g., a GPT). The GPT may be a deep learning language model that is pre-trained on a large text corpus and can optionally be fine-tuned using the disclosed objective function-based item assortment selection techniques. The language model 610 and agent 650 provide a conversational chatbot for user queries, and optionally validates and understands the context of a user query, for example.

The memory 620 may be employed to save conversations with the user 690, as well as other context. The chat history with a particular user 690 may be appended to a user prompt that is provided to the language model 610 to better contextualize the user queries (e.g., thereby giving a compelling, coherent conversation).

The assortment optimizer 630 implements the disclosed techniques for objective function-based item assortment selection in order to generate item assortments (e.g., product catalogs) as well as to generate a corresponding quality report (indicating, for example, a percentage of attainment and/or a characterization of the URM metric), comparing the performance of a given item assortment against historical benchmarks.

The language model 610 may process user requests to generate new item assortments, or to update an existing item assortment based at least in part on user provided preferences, changes, business goals and/or attainment goals. The language model 610 parses a user query and converts the user query into one or more designated business constraints (e.g., attainment goals) and one or more optimization function targets (e.g., maximization goals). The agent 650 passes the designated business constraints and optimization function targets to the assortment optimizer 630 for an item assortment generation in accordance with the techniques discussed above in conjunction with FIG. 4, for example. In addition, user queries directed to analytics requests may be converted to a SQL query for ad hoc analytics requests on item assortment historical performances.

The agent 650 can thus interact with a user 690 to obtain attainment and maximization goals from the user 690. A subject matter expert can provide feedback on a given selected item assortment provided by the agent 650, so that the language model 610 can learn to generate better item assortments.

In the example of FIG. 6, the item assortment user interface 660 comprises a chat assistant dialogue window 670, a selected item assortment window 675 and an available tool icons window 680. The chat assistant dialogue window 670 may display a dialogue between the user 690 and the agent 650. For example, a representative dialogue may comprise:
Agent: “How can I help you today?”
User: “Please help me generate an item assortment for Norway with constraints x, y and z, that maximizes performance factor A (having a 50% weight) and performance factor B (having a 50% weight).”
Agent: “Sure, executing the item assortment optimizer.”
Agent: “Generating the quality report.”
Agent: “Item assortment is now available in the selected item assortment window 675 along with the corresponding quality report. Should I go publish the selected item assortment on ABC.com?”
User: “Change the constraint values to x′, y′ and z′ and execute the item assortment optimizer again.”
Agent: “Sure, executing the item assortment optimizer with the updated constraint values.”
Agent: “The updated item assortment is now available in the selected item assortment window 675 along with the corresponding quality report. Should I go publish the updated item assortment on ABC.com?”
User: “Yes, proceed with the publishing.”
Agent: “The new item assortment has been published on ABC.com.”

The agent 650 can optionally leverage the tools 640 to answer analytical queries and/or to publish an item assortment on downstream applications (e.g., designated web sites). The tools 640 may comprise, for example, one or more forecasting tools, historical performance processing tools and/or web site metric processing tools). An icon for each of the available tools 640 can be provided in the available tool icons window 680 for selection by a user.

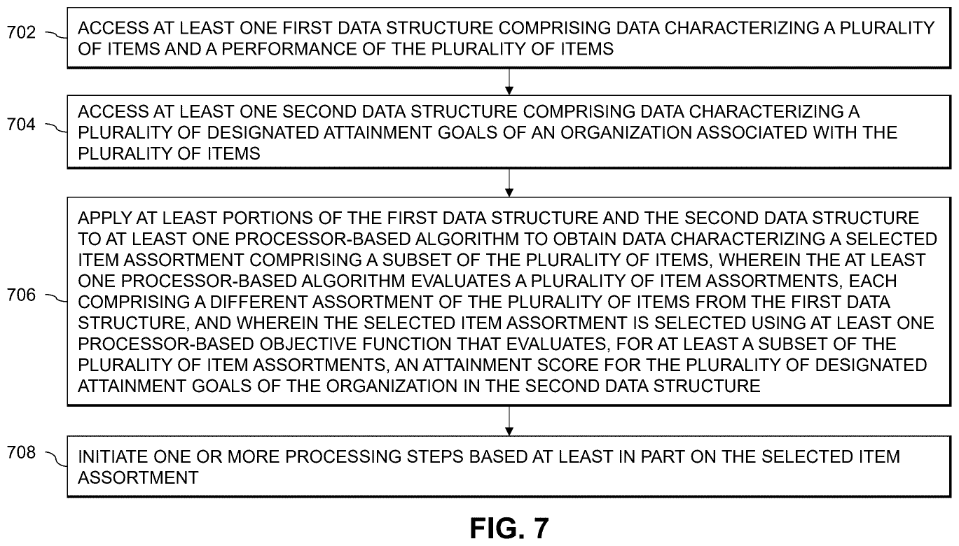

FIG. 7 is a flow diagram illustrating an exemplary implementation of a process for automated item assortment selection using processor-based objective function evaluation of designated goal scores in accordance with an illustrative embodiment. In the example of FIG. 7, at least one first data structure is accessed in step 702 comprising data characterizing a plurality of items and a performance of the plurality of items. At least one second data structure is accessed in step 704 comprising data characterizing a plurality of designated attainment goals of an organization associated with the plurality of items.

At least portions of the first data structure and the second data structure are applied in step 706 to at least one processor-based algorithm to obtain data characterizing a selected item assortment comprising a subset of the plurality of items, where the at least one processor-based algorithm evaluates a plurality of item assortments, each comprising a different assortment of the plurality of items from the first data structure, and wherein the selected item assortment is selected using at least one processor-based objective function that evaluates, for at least a subset of the plurality of item assortments, an attainment score for the plurality of designated attainment goals of the organization in the second data structure.

One or more processing steps may be initiated in step 708 based at least in part on the selected item assortment.

It should be noted that the term “data structure” as used herein is intended to be broadly construed. A data structure, such as any single one of or combination of the first and second data structures referred to above, may provide a portion of a larger data structure, or any one of or combination of the first and second data structures may be combinations of multiple smaller data structures. Therefore, the first and second data structures referred to above may be different parts of a same overall data structure, or one or more of the first and second data structures could be made up of multiple smaller data structures. The data structures may include tables, vectors, embeddings, or various other data structures. In some embodiments, the data structures are specifically formatted or generated such that they are suitable for use as at least one of an input to and an output from an ML model. It should further be appreciated that “generating” a data structure may encompass, for example, populating an existing or previously-created data structure with one or more data items and that “accessing” a data structure may encompass, for example, obtaining a portion (e.g., one or more data items) of one or more data structures by means of a query, select or filter operation, for example. Likewise, “accessing” first and second data structures may encompass obtaining one or more data items from different parts of a same overall data structure.

In at least one embodiment, the plurality of designated attainment goals of the organization comprises a plurality of target attainment goals and at least one maximization goal that increases (e.g., substantially maximizes) towards a designated business objective. The at least one processor-based objective function may evaluate the at least one maximization goal in response to the plurality of target attainment goals being satisfied. The at least one algorithm may be based at least in part on a GA or a linear integer programming algorithm that generates at least some of the plurality of item assortments, and wherein a given item assortment in a population of item assortments is maintained in the population for a next iteration of the GA in response to a score generated using the at least one processor-based objective function being higher than the score for a prior iteration.

In one or more embodiments, the data characterizing the performance of the plurality of items comprises at least one forecasted demand for at least some of the plurality of items in connection with one or more temporal periods. The at least one forecasted demand data for one or more of the plurality of items may be generated using at least one ratio forecasting model, and the at least one ratio forecasting model may process at least one first forecast generated for at least one item in a first item hierarchy level and generate at least one second forecast for one or more items in a lower item hierarchy level using an item-level ratio for the one or more items in the lower item hierarchy level. The at least one forecasted demand for the at least some of the plurality of items may be based at least in part on one or more of demand data for at least one competitor of the organization and trend data for at least one market comprising the organization.

In some embodiments, the at least one forecasted demand for the at least some of the plurality of items may be associated with a given geographic area, and the at least one forecasted demand for at least some of the plurality of items for the given geographic area may be generated by processing at least one forecasted demand for at least some of the plurality of items associated with at least one different geographic area, than the given geographic area, that satisfies one or more designated similarity criteria with respect to the given geographic area. One or more aspects of the disclosure recognize that for a smaller market, for example, item assortment planning may be performed based at least in part on item factors analyzed with respect to a similar country having a bigger market. It may not be feasible to allocate a dedicated team to implement such solutions for regions that are small in size, for example. It is often challenging to implement solutions planned for a large region or country and replicate such solutions in smaller regions or countries (e.g., smaller with respect to revenue and/or population size). For example, the generated solution may not be well suited for one or more specific target markets.

In some embodiments, the one or more processing steps comprise at least one of: generating a notification for approval of the selected item assortment, publishing the selected item assortment and causing an action to be performed in another system using the selected item assortment. A language model-based agent may be provided to (i) process a request from a user to generate an item assortment that satisfies at least some of the plurality of designated attainment goals and (ii) provide the at least some designated attainment goals to an item assortment selection system that determines the selected item assortment using the at least some designated attainment goals.

The particular processing operations and other network functionality described in conjunction with FIGS. 2 through 4, 6 and 7, for example, are presented by way of illustrative example only, and should not be construed as limiting the scope of the disclosure in any way. Alternative embodiments can use other types of processing operations for automated item assortment selection using processor-based objective function evaluation of designated goal scores. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

One or more embodiments of the disclosure provide improved methods, apparatus and computer program products for automated item assortment selection using processor-based objective function evaluation of designated goal scores. The foregoing applications and associated embodiments should be considered as illustrative only, and numerous other embodiments can be configured using the techniques disclosed herein, in a wide variety of different applications.

It should also be understood that the disclosed techniques for automated item assortment selection using processor-based objective function evaluation of designated goal scores, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for automated item assortment selection using processor-based objective function evaluation of designated goal scores may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based objective function-based item assortment selection engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based objective function-based item assortment selection platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

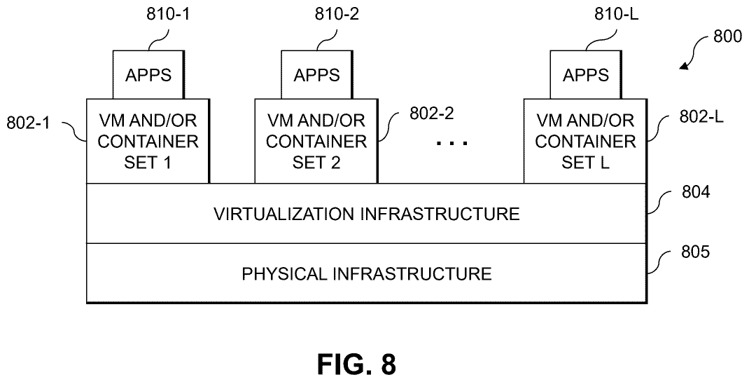

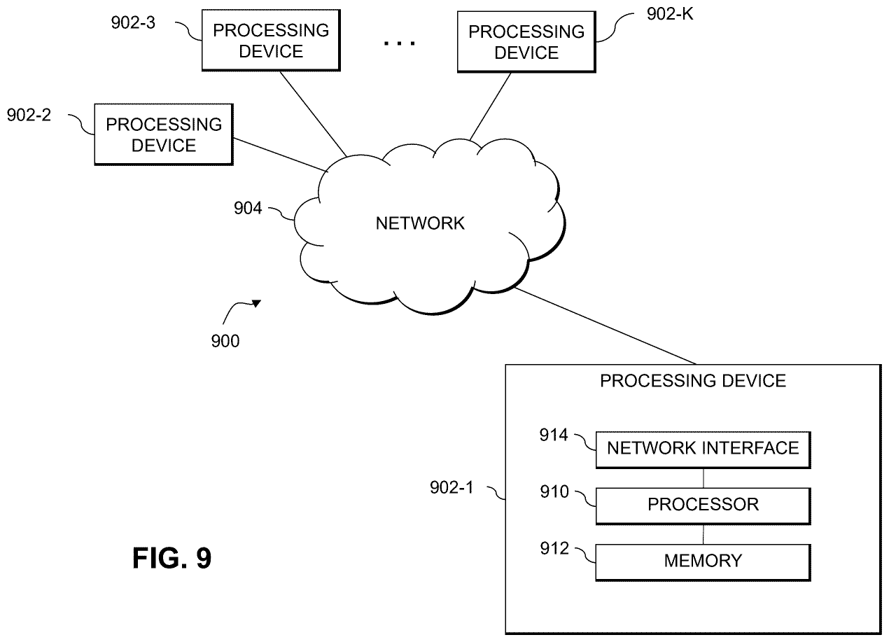

Illustrative embodiments of processing platforms will now be described in greater detail with reference to FIGS. 8 and 9. These platforms may also be used to implement at least portions of other information processing systems in other embodiments.

FIG. 8 shows an example processing platform comprising cloud infrastructure 800. The cloud infrastructure 800 comprises a combination of physical and virtual processing resources that may be utilized to implement at least a portion of the information processing system 100. The cloud infrastructure 800 comprises multiple virtual machines (VMs) and/or container sets 802-1, 802-2, . . . 802-L implemented using virtualization infrastructure 804. The virtualization infrastructure 804 runs on physical infrastructure 805, and illustratively comprises one or more hypervisors and/or operating system level virtualization infrastructure. The operating system level virtualization infrastructure illustratively comprises kernel control groups of a Linux operating system or other type of operating system.

The cloud infrastructure 800 further comprises sets of applications 810-1, 810-2, . . . 810-L running on respective ones of the VMs/container sets 802-1, 802-2, . . . 802-L under the control of the virtualization infrastructure 804. The VMs/container sets 802 may comprise respective VMs, respective sets of one or more containers, or respective sets of one or more containers running in VMs.

In some implementations of the FIG. 8 embodiment, the VMs/container sets 802 comprise respective VMs implemented using virtualization infrastructure 804 that comprises at least one hypervisor. Such implementations can provide objective function-based item assortment selection functionality of the type described above for one or more processes running on a given one of the VMs. For example, each of the VMs can implement control logic for objective function-based item assortment selection and associated functionality for evaluating designated attainment goals.

An example of a hypervisor platform that may be used to implement a hypervisor within the virtualization infrastructure 804 is a compute virtualization platform which may have an associated virtual infrastructure management system such as server management software. The underlying physical machines may comprise one or more distributed processing platforms that include one or more storage systems.

In other implementations of the FIG. 8 embodiment, the VMs/container sets 802 comprise respective containers implemented using virtualization infrastructure 804 that provides operating system level virtualization functionality, such as support for Docker containers running on bare metal hosts, or Docker containers running on VMs. The containers are illustratively implemented using respective kernel control groups of the operating system. Such implementations can provide objective function-based item assortment selection functionality of the type described above for one or more processes running on different ones of the containers. For example, a container host device supporting multiple containers of one or more container sets can implement one or more instances of control logic for objective function-based item assortment selection and associated functionality for evaluating designated attainment goals.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 800 shown in FIG. 8 may represent at least a portion of one processing platform. Another example of such a processing platform is processing platform 900 shown in FIG. 9.

The processing platform 900 in this embodiment comprises at least a portion of the given system and includes a plurality of processing devices, denoted 902-1, 902-2, 902-3, . . . 902-K, which communicate with one another over a network 904. The network 904 may comprise any type of network, such as a WAN, a LAN, a satellite network, a telephone or cable network, a cellular network, a wireless network such as WiFi or WiMAX, or various portions or combinations of these and other types of networks.

The processing device 902-1 in the processing platform 900 comprises a processor 910 coupled to a memory 912. The processor 910 may comprise a microprocessor, a microcontroller, an ASIC, an FPGA, a CPU, a GPU, a TPU, a VPU, an NPU, a DPU, an SOC or other type of processing circuitry, as well as portions or combinations of such circuitry elements, and the memory 912, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage drive or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 902-1 is network interface circuitry 914, which is used to interface the processing device with the network 904 and other system components, and may comprise conventional transceivers.

The other processing devices 902 of the processing platform 900 are assumed to be configured in a manner similar to that shown for processing device 902-1 in the figure.

Again, the particular processing platform 900 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 8 or 9, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
accessing at least one first data structure comprising data characterizing a plurality of items and a performance of the plurality of items;
accessing at least one second data structure comprising data characterizing a plurality of designated attainment goals of an organization associated with the plurality of items;
applying at least portions of the first data structure and the second data structure to at least one processor-based algorithm to obtain data characterizing a selected item assortment comprising a subset of the plurality of items, wherein the at least one processor-based algorithm evaluates a plurality of item assortments, each comprising a different assortment of the plurality of items from the first data structure, and wherein the selected item assortment is selected using at least one processor-based objective function that evaluates, for at least a subset of the plurality of item assortments, an attainment score for the plurality of designated attainment goals of the organization in the second data structure; and
initiating one or more processing steps based at least in part on the selected item assortment;
wherein the method is performed by at least one processing device comprising a processor coupled to a memory.

2. The method of claim 1, wherein the plurality of designated attainment goals of the organization comprises a plurality of target attainment goals and at least one maximization goal that increases towards a designated business objective.

3. The method of claim 2, wherein the at least one processor-based objective function evaluates the at least one maximization goal in response to the plurality of target attainment goals being satisfied.

4. The method of claim 1, wherein the at least one processor-based algorithm is based at least in part on a genetic algorithm or a linear integer programming algorithm that generates at least some of the plurality of item assortments, and wherein a given item assortment in a population of item assortments is maintained in the population for a next iteration of the genetic algorithm in response to a score generated using the at least one processor-based objective function being higher than the score for a prior iteration.

5. The method of claim 1, wherein the data characterizing the performance of the plurality of items comprises at least one forecasted demand for at least some of the plurality of items in connection with one or more temporal periods.

6. The method of claim 5, wherein the at least one forecasted demand for one or more of the plurality of items is generated using at least one ratio forecasting model, and wherein the at least one ratio forecasting model processes at least one first forecast generated for at least one item in a first item hierarchy level and generates at least one second forecast for one or more items in a lower item hierarchy level using an item-level ratio for the one or more items in the lower item hierarchy level.

7. The method of claim 5, wherein the at least one forecasted demand for the at least some of the plurality of items is associated with a given geographic area, and wherein the at least one forecasted demand for at least some of the plurality of items for the given geographic area is generated by processing at least one forecasted demand for at least some of the plurality of items associated with at least one different geographic area, than the given geographic area, that satisfies one or more designated similarity criteria with respect to the given geographic area.

8. The method of claim 5, wherein the at least one forecasted demand for the at least some of the plurality of items is based at least in part on one or more of demand data for at least one competitor of the organization and trend data for at least one market comprising the organization.

9. The method of claim 1, wherein the one or more processing steps comprise at least one of: generating a notification for approval of the selected item assortment, publishing the selected item assortment and causing an action to be performed in another system using the selected item assortment.

10. The method of claim 1, wherein a language model-based agent processes a request from a user to generate an item assortment that satisfies at least some of the plurality of designated attainment goals and provides the at least some designated attainment goals to an item assortment selection system that determines the selected item assortment using the at least some designated attainment goals.

11. An apparatus comprising:
at least one processing device comprising a processor coupled to a memory;
the at least one processing device being configured to implement the following steps:
accessing at least one first data structure comprising data characterizing a plurality of items and a performance of the plurality of items;
accessing at least one second data structure comprising data characterizing a plurality of designated attainment goals of an organization associated with the plurality of items;
applying at least portions of the first data structure and the second data structure to at least one processor-based algorithm to obtain data characterizing a selected item assortment comprising a subset of the plurality of items, wherein the at least one processor-based algorithm evaluates a plurality of item assortments, each comprising a different assortment of the plurality of items from the first data structure, and wherein the selected item assortment is selected using at least one processor-based objective function that evaluates, for at least a subset of the plurality of item assortments, an attainment score for the plurality of designated attainment goals of the organization in the second data structure; and
initiating one or more processing steps based at least in part on the selected item assortment.

12. The apparatus of claim 11, wherein the plurality of designated attainment goals of the organization comprises a plurality of target attainment goals and at least one maximization goal that increases towards a designated business objective, wherein the at least one processor-based objective function evaluates the at least one maximization goal in response to the plurality of target attainment goals being satisfied.

13. The apparatus of claim 11, wherein the at least one processor-based algorithm is based at least in part on a genetic algorithm or a linear integer programming algorithm that generates at least some of the plurality of item assortments, and wherein a given item assortment in a population of item assortments is maintained in the population for a next iteration of the genetic algorithm in response to a score generated using the at least one processor-based objective function being higher than the score for a prior iteration.

14. The apparatus of claim 11, wherein the data characterizing the performance of the plurality of items comprises at least one forecasted demand for at least some of the plurality of items in connection with one or more temporal periods, and wherein the at least one forecasted demand for one or more of the plurality of items is one or more of (i) generated using at least one ratio forecasting model, and wherein the at least one ratio forecasting model processes at least one first forecast generated for at least one item in a first item hierarchy level and generates at least one second forecast for one or more items in a lower item hierarchy level using an item-level ratio for the one or more items in the lower item hierarchy level and (ii) associated with a given geographic area, and wherein the at least one forecasted demand for at least some of the plurality of items for the given geographic area is generated by processing at least one forecasted demand for at least some of the plurality of items associated with at least one different geographic area, than the given geographic area, that satisfies one or more designated similarity criteria with respect to the given geographic area.

15. The apparatus of claim 11, wherein a language model-based agent processes a request from a user to generate an item assortment that satisfies at least some of the plurality of designated attainment goals and provides the at least some designated attainment goals to an item assortment selection system that determines the selected item assortment using the at least some designated attainment goals.

16. A non-transitory processor-readable storage medium having stored therein program code of one or more software programs, wherein the program code when executed by at least one processing device causes the at least one processing device to perform the following steps:
accessing at least one first data structure comprising data characterizing a plurality of items and a performance of the plurality of items;
accessing at least one second data structure comprising data characterizing a plurality of designated attainment goals of an organization associated with the plurality of items;
applying at least portions of the first data structure and the second data structure to at least one processor-based algorithm to obtain data characterizing a selected item assortment comprising a subset of the plurality of items, wherein the at least one processor-based algorithm evaluates a plurality of item assortments, each comprising a different assortment of the plurality of items from the first data structure, and wherein the selected item assortment is selected using at least one processor-based objective function that evaluates, for at least a subset of the plurality of item assortments, an attainment score for the plurality of designated attainment goals of the organization in the second data structure; and
initiating one or more processing steps based at least in part on the selected item assortment.

17. The non-transitory processor-readable storage medium of claim 16, wherein the plurality of designated attainment goals of the organization comprises a plurality of target attainment goals and at least one maximization goal that increases towards a designated business objective, wherein the at least one processor-based objective function evaluates the at least one maximization goal in response to the plurality of target attainment goals being satisfied.

18. The non-transitory processor-readable storage medium of claim 16, wherein the at least one processor-based algorithm is based at least in part on a genetic algorithm or a linear integer programming algorithm that generates at least some of the plurality of item assortments, and wherein a given item assortment in a population of item assortments is maintained in the population for a next iteration of the genetic algorithm in response to a score generated using the at least one processor-based objective function being higher than the score for a prior iteration.

19. The non-transitory processor-readable storage medium of claim 16, wherein the data characterizing the performance of the plurality of items comprises at least one forecasted demand for at least some of the plurality of items in connection with one or more temporal periods, and wherein the at least one forecasted demand for one or more of the plurality of items is one or more of (i) generated using at least one ratio forecasting model, and wherein the at least one ratio forecasting model processes at least one first forecast generated for at least one item in a first item hierarchy level and generates at least one second forecast for one or more items in a lower item hierarchy level using an item-level ratio for the one or more items in the lower item hierarchy level and (ii) associated with a given geographic area, and wherein the at least one forecasted demand for at least some of the plurality of items for the given geographic area is generated by processing at least one forecasted demand for at least some of the plurality of items associated with at least one different geographic area, than the given geographic area, that satisfies one or more designated similarity criteria with respect to the given geographic area.

20. The non-transitory processor-readable storage medium of claim 16, wherein a language model-based agent processes a request from a user to generate an item assortment that satisfies at least some of the plurality of designated attainment goals and provides the at least some designated attainment goals to an item assortment selection system that determines the selected item assortment using the at least some designated attainment goals.
